(19) United States
(12) Patent Application Publication
(10) Pub. No.: US 2005/0082324 A1
(43) Pub. Date: Apr. 21, 2005

(54) Article carrier and bicycle rack system

(76) Inventor: Bradley S. Schlachter, Carlsbad, CA (US)

Correspondence Address: David H. Judson;Locke, Liddell & Sapp, LLP, Suite 2200, 2200 Ross Avenue, Dallas, TX, 75201, US

(21) Appl. No.: 10/689,349

(22) Filed: Oct. 20, 2003

(51) Int. Cl. B60R 9/00

(52) U.S. Cl. 224/319; 224/924

(57) ABSTRACT

An angled vehicle article carrier and bicycle rack system for providing a unique, safe and secure method of attaching bicycles to vehicle article carrying systems for trucks and autos while also providing space efficiencies, security and ease of use. The inventive device includes a single roof rail system that secures the front forks of a bicycle on the roof of a truck or vehicle and the rear tire being secured to the bed of a truck or the lower back portion of a vehicle. The roof rail system is attached to the roof of a vehicle. The front forks of the bicycle are secured to a mounting system that securely attaches to the roof rails. The mounting system securely attaches to single roof rail system and the bicycle forks attach to the mounting system. One end of the mounting system is endowed with a quick release apparatus that fastens or unfastens the bicycle forks. The security apparatus consists of an existing attachment system, whether a bracket, a bungee cord or a security strap, that secures the rear of the bicycle to either the bed of a truck or to the rear of a vehicle.

### BACKGROUND OF THE INVENTION

1. Field of the Invention

The present invention relates generally to vehicle article carrier systems and, in particular, the invention relates to a system for providing a unique, safe and secure method of attaching bicycles or similar items to a vehicle, such as a sport utility vehicle, flat-bed pick-up truck, or other automobile, while also providing space efficiencies, security and ease of use.

2. Description of the Prior Art

Vehicle article carrier systems have been in use for years. Typically, a vehicle article carrier system is comprised of a set of racks and associated devices that hold given articles in a horizontal position on the top of a car or van, or in the bed of a truck, or attached to a vehicle hitch. Bicycle carrier systems are especially popular, as bicycles are frequently transported. Numerous racks and devices have been devised to secure bicycles to vehicles during transport. One particularly common bicycle carrier utilizes a fork block mounted to a rack structure. The fork block has a skewer that clamps the front forks (sometimes referred to as a “fork”) of a bicycle to secure the bicycle to the rack. The clamping pressure of the skewer on the forks is sufficient to stabilize the bicycle against tipping during travel. Typically, a wheel tray extends back from the fork block to support the rear wheel.

A main problem with conventional vehicle bicycle carrier systems of this type are that when a bicycle is secured to the top of a vehicle, the additional height of the bicycle makes driving more difficult and parking in standard garages impossible. Indeed, in many circumstances, the additional height of the bicycle actually can cause a driving hazard. While these and associated problems with top-mounted systems can be avoided by other, such as hitch-mounted, systems, still other problems exist. Thus, for example, where the bicycle is attached to the hitch of a vehicle, the attachments that are employed are cumbersome and difficult to use. Flat bed truck carrier systems, likewise, have problems of their own. Thus, when a bicycle is secured horizontally in the truck bed, the bicycle often takes up the majority of the truck's cargo space. If the bicycle is not rigidly secured, it may dislodge and create a driving hazard or damage the bicycle.

While these devices may be suitable for the particular purpose to which they address, they do not provide a unique, safe and secure method of attaching bicycles to vehicle article carrying systems for trucks and autos while also providing space efficiencies, security and ease of use.

In these respects, the vehicle article carrier and bicycle rack system according to the present invention substantially departs from the conventional concepts and designs of the prior art, and in so doing provides an apparatus primarily developed for the purpose of providing a unique, safe and secure method of attaching bicycles to vehicle article carrying systems for trucks and automobiles while also providing space efficiencies, security and ease of use.

### BRIEF SUMMARY OF THE INVENTION

The present invention is a system for use in conjunction with a vehicle and an article, such as a bicycle, that a user desires to carry on or in association with the vehicle. Although not required to be part of the inventive system, it is assumed the vehicle has a first support surface extending in a plane, as well as a second support surface, and the bicycle has a fork in which a wheel is normally mounted, as well as an opposing wheel. The first support surface typically is located above the second support surface, when viewed in elevation. The system comprises a support member that is adapted to be secured to the first support surface of the vehicle, together with a mount. According to the invention, the mount is attachable to the support member and is adapted to receive and secure the fork of the bicycle for rotation about an axis extending through the mount such that, with the fork secured to the mount, the bicycle is positioned at a given angle relative to the plane of the first support surface, with the opposing wheel of the bicycle located on or adjacent the second support surface. The system may also include a component that is adapted to secure the opposing wheel of the bicycle on or adjacent the second support surface.

Typically, as noted above, the vehicle's first support surface is located above the second support surface. As a consequence, when the support member is secured to the first support surface and the bicycle fork is attached to the mount, the bicycle frame can rotate downward relative to the first support surface so that the bicycle's opposing wheel may come to rest on the second support surface. This alignment results in the bicycle being positioned at an angle (e.g., of approximately 45° with respect to a plane of the second support surface or −45° with respect to the plane of the first support surface).

In a representative embodiment, there is a single support member attached to the roof of a truck having an enclosed bed, such as a conventional pick-up truck. The single support member typically is a crossbar, and it may be conveniently located in the same position as a conventional roof-mounted “spoiler.” In an alternative embodiment, a fork mount (provided as an add-on or “aftermarket” product) may simply be attached to an existing spoiler to facilitate the present invention.

According to a more detailed embodiment, a rack for carrying a bicycle on a vehicle such as an open bed truck comprises a single crossbar, a pair of tower mechanisms configured to secure the crossbar to the top of the vehicle, a fork block attached to the crossbar, and an assembly to secure a rear wheel of the bicycle. The fork block includes a skewer assembly, together with an actuator handle moveable between clamped and unclamped positions. A bicycle fork is secured in the fork block and permitted to rotate about the block so that a rear wheel of the bicycle comes to rest in the bed of the open bed vehicle. The rear wheel is then secured to the truck bed to prevent lateral or up and down movement as the vehicle moves. The bicycle is then fixed at an approximately 45° with respect to the horizontal.

The present invention is not limited for use with an open bed truck vehicle. In an alternative embodiment, the bicycle is hung off the back of a back of the vehicle (such as an sport utility or SUV) roof, with the back wheel thereof coming to rest on a back bumper of the vehicle. In yet another alternative embodiment, the single support member is attached to a side rail of an open be vehicle, with the bicycle positioned sideways in the truck bed.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a perspective view of a bicycle mount according to the present invention;

FIG. 2 is a perspective view of the bicycle mount of FIG. 1 adapted for attachment to a vehicle support member;

FIG. 3 is a perspective view of the bicycle mount of FIG. 2 after it has been attached to the vehicle support member and a fork of a bicycle is secured in the mount;

FIG. 4 illustrates a preferred embodiment of the present invention for use in conjunction with a vehicle and a bicycle, wherein the bicycle mount is adapted to receive and secure a fork of the bicycle for rotation about an axis extending through the mount such that, with the fork secured to the mount, the bicycle is positioned at a given angle relative to the plane of a first support surface, and wherein the opposing wheel of the bicycle is then located on or adjacent the second support surface;

FIG. 5 illustrates a perspective view as in FIG. 3 with the mount moved to a released position to enable the bicycle fork to be removed from the mount;

FIG. 6 is an end view showing the mount along lines 6-6′ of FIG. 3;

FIG. 7 is an end view showing the mount along lines 7-7′ of FIG. 5;

FIG. 8 illustrates an alternative embodiment of the invention with the bicycle mount secured to a side rail of a truck to enable a bicycle to be supported across the truck bed; and

FIG. 9 illustrates another alternative embodiment of the invention implemented on a back of a vehicle.

### DETAILED DESCRIPTION

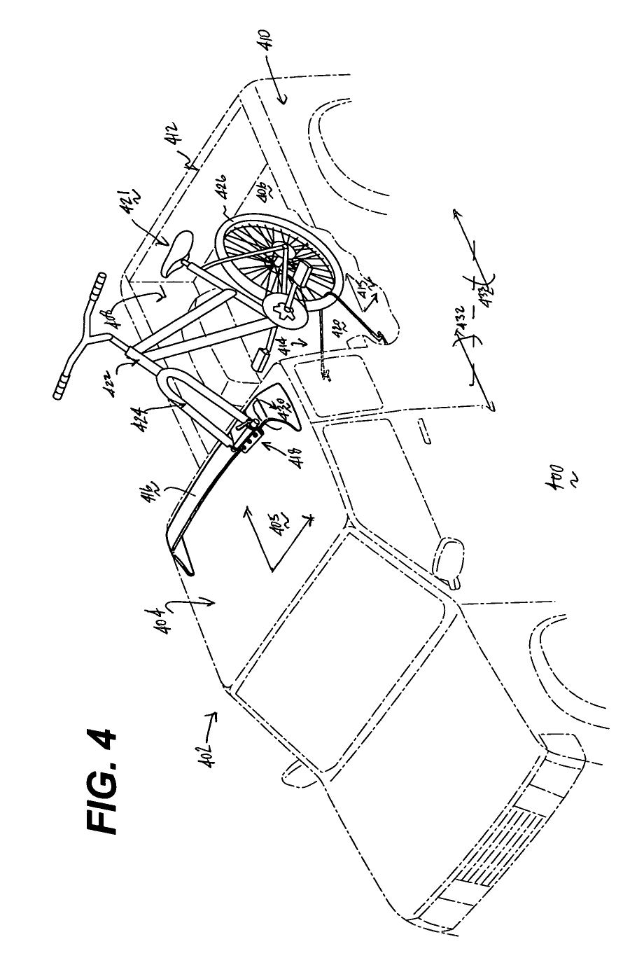

The present invention is adapted for use with various types of vehicles. For purposes of illustration only, one type of vehicle in which the invention may be implemented is a conventional pick-up style truck, such as the vehicle illustrated in FIG. 4. The truck 400 comprises a cab 402 having a roof 404. The roof 404 is a first support surface that extends in a generally horizontal plane designated by reference numeral 405. The bed area 406 of the truck is defined generally by a pair of opposing side panels 408 and 410, and a rear door 412. The bed 406 includes a floor 414. The floor 414 of the truck bed is a second support surface that extends in a generally horizontal plane designated generally by the reference number 415. As is self-evident, from an elevation or side view, first support surface 405 is located above second support surface 415. The present invention takes unique advantage of this planar relationship as will be seen. A system of the present invention is used to secure an article to the vehicle. For illustrative purposes only, the article is assumed to be a bicycle 421, although with minor variations the invention may be used to secure other types of elongated articles. Bicycle 421 comprises, among other parts, a frame 422, a fork 424 in which a first wheel (not shown) is normally mounted, and an opposing wheel 426.

Thus, in general, the present invention is a system for use in conjunction with a vehicle and a bicycle, the vehicle having a first support surface extending in a plane, and a second support surface; the bicycle having a fork in which a wheel is normally mounted, and an opposing wheel. When the system is provided as an add-on or so-called “aftermarket” product, the vehicle and bicycle are not necessarily part of the inventive system. In an alternative embodiment, the system is implemented as original equipment with a vehicle, in which case the invention is adapted as an improvement to the existing vehicle itself. Of course, a skilled artisan will appreciate that the present invention is not limited for use with any particular type of vehicle, or any particular type of article. Any vehicle that has first and second support surfaces that are located in different planes may use the present invention, as will be seen.

FIG. 4 illustrates three (3) basic components that comprise an implementation of the inventive article securing system. The system comprises a support member 416 adapted to be secured to the first support surface 404 of the vehicle 400, a mount 418 attachable to the support member 416, and a security component 420. In one embodiment, support member 416 is an aerodynamically extruded aluminum alloy crossbar, such as a conventional spoiler, which is designed to minimize drag on and wind noise in the vehicle cab. As illustrated generally in FIG. 4, the mount 418 is adapted to receive and secure the fork 424 of the bicycle 421 for rotation about an axis 430 extending through the mount such that, with the fork secured to the mount, the bicycle is positioned at a given angle 432 relative to the plane of the first support surface 404 (or at a given angle 433 relative to the plane of the second support surface 414) with the opposing wheel of the bicycle located on or adjacent the truck bed floor, i.e., the second support surface. The security component 420 is adapted to secure the opposing wheel 426 of the bicycle 421 to the second support surface 414 to tightly secure the bicycle against horizontal, vertical or lateral movement.

In this embodiment, the security component is a strap or cord. This is merely illustrative. The security component may be a bracket, a bungee cord, a tether, or a combination of such devices, or other conventional fasteners. The security component may also include an integral or separate locking mechanism. Still another alternative is to secure the wheel against movement by positioning the wheel within a slot or opening in the bed.

As one of ordinary skill will readily appreciate, the inventive system provides a unique, safe and secure method of attaching bicycles or similar items to a vehicle at an “angle” relative to the horizontal. This highly beneficial support system overcomes many of the problems of the prior art, for example, by reducing the height of the vehicle when the bicycle is being carried, by preventing movement of the bicycle, by reducing the amount of hardware needed, and by providing a simple and secure mechanism. Of course, the “angle” is created by use of a single support member located at or near a rear (or back) edge of the vehicle roof so that the bicycle fork may be secured in the mount but still rotate freely about this pivot point. The major portion of the bicycle frame is then positioned within the truck bed by virtue of being rotated downward with respect to the end of the fork, which is retained in the mount at or adjacent the height of the vehicle roof. Once the opposing (e.g., the back) wheel of the bicycle is secured by the security component, the bicycle is positioned at an angle relative to the horizontal, but is safely and securely carried.

The particular angle at which the article is carried is not a limitation of the invention. Typically, when viewed from above that angle (reference numeral 432) will be about −45° relative to the first support surface 404; of course, when viewed from below the angle (reference numeral 433) will be about +45° relative to the second support surface 414.

Thus, according to an illustrative embodiment of the present invention as illustrated in FIG. 4, a bicycle mounting system includes a roof-mounted crossbar that attaches to the roof of the vehicle. The crossbar may be an integrally apparatus, or it may comprise a separate bar attached roof-mounted towers. A bicycle to be secured has a quick release front wheel. Once the wheel is removed, the wheel forks are clamped in the bike fork, the bike is rotated about the bike mount and allowed to come to rest in the back of the open bed truck. The back wheel is then secured.

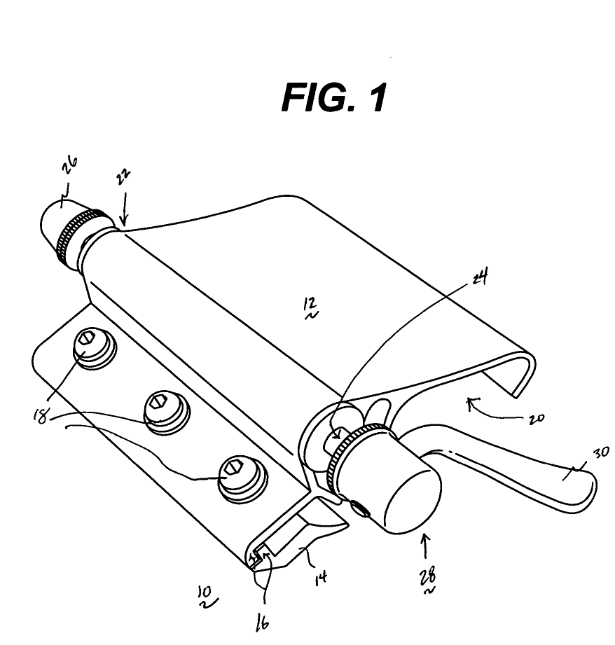

FIGS. 1-3 illustrate a fork mount 10 for use on the crossbar. Fork mount comprises a molded plastic or formed metal body 10 with an upper section 12 and a lower section 14. Facing portions of each section are formed with stepped edges 16 that interlock with each other. The two sections are secured together by a set of bolts 18 that engage corresponding fasteners (not shown). The upper and lower sections 12 and 14 cooperate to form a channel 20 adapted to receive the crossbar. One of ordinary skill will appreciate that the particular configuration of the upper and lower sections is designed to match or align with the particular configuration of the crossbar so that the form mount may be securely and fixedly attached to the crossbar.

As best seen in FIG. 1, the upper section of the fork mount includes a passage 22 configured to receive an elongated skewer 24. Skewer 24 is designed to rotate within the passage in a conventional manner. A skewer bolt 26 secures an end of the skewer, and the opposed end of the skewer includes a quick release mechanism 28. The mechanism 28 includes a handle portion 30 to allow a user to secure bicycle forks to the mount in a conventional manner. Although not shown, the fork mount may include a locking mechanism to prevent the handle portion 30 from being opened.

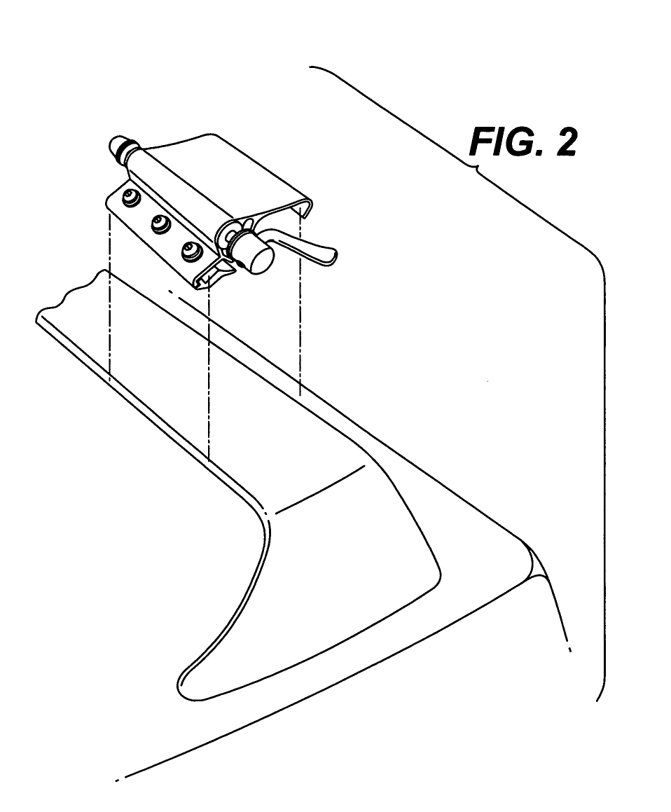

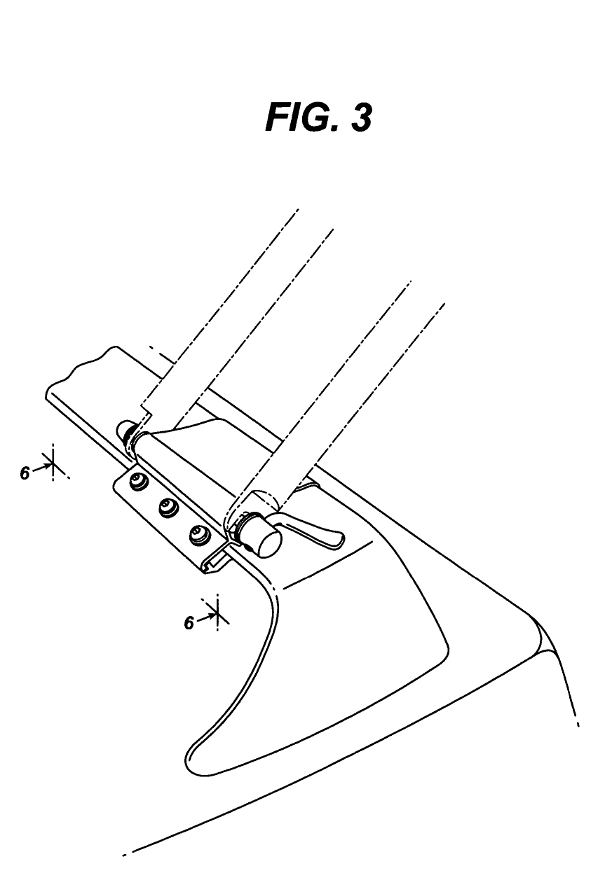

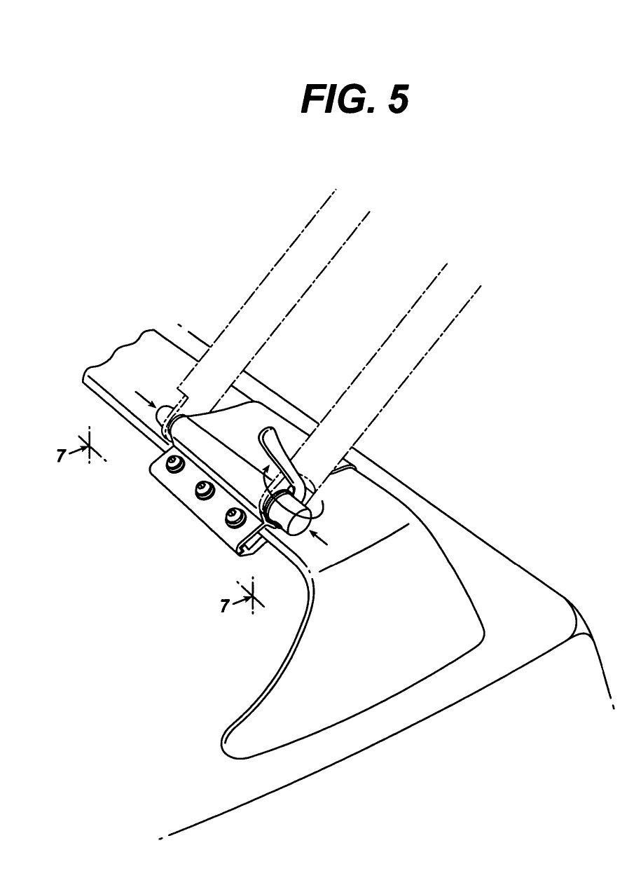

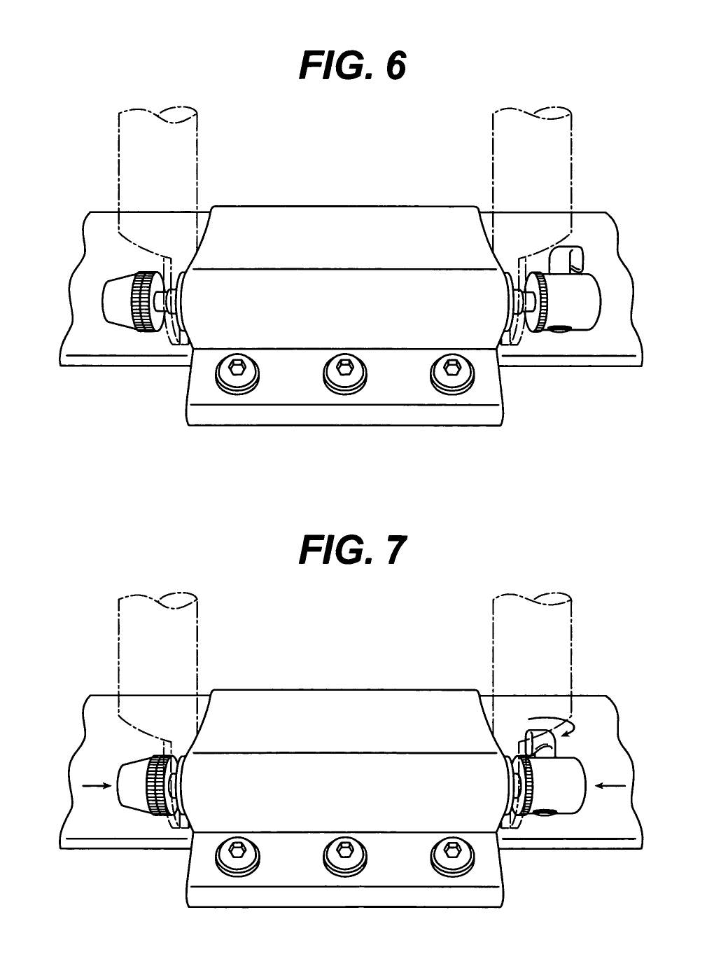

As illustrated in FIG. 2, the fork mount is adapted to be attached to the crossbar that, as noted above, may be an existing spoiler. FIG. 3 illustrates how the bicycle forks are positioned in the fork mount, and FIG. 5 illustrates the handle portion being moved to its locked position to secure the bicycle forks. FIGS. 6-7 illustrate the unlocked and locked position of the fork mount quick release mechanism.

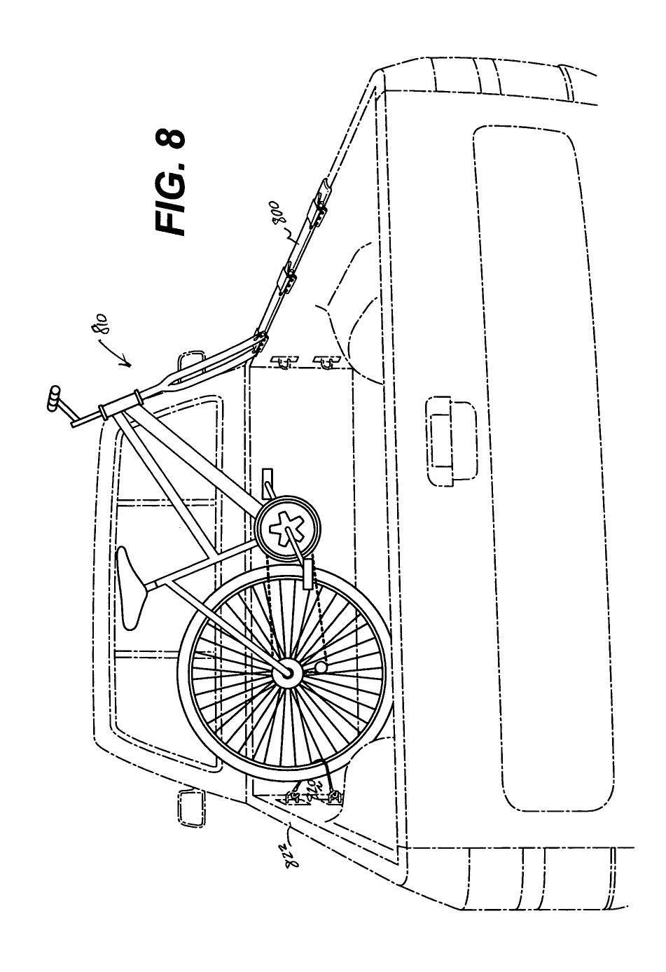

FIG. 8 illustrates an alternative embodiment of the invention. In this embodiment, the support member is a rail 800 secured to a side rail of the open bed vehicle. One or more fork mounts are then secured to the side rail, and one or more bicycles 810 are then supported in the manner illustrated in FIG. 8. In this embodiment, it can be seen that the security component 820 is attached to the opposed side panel 822 instead of to the open bed floor. Of course, a similar type of securing arrangement can be used in the other embodiment.

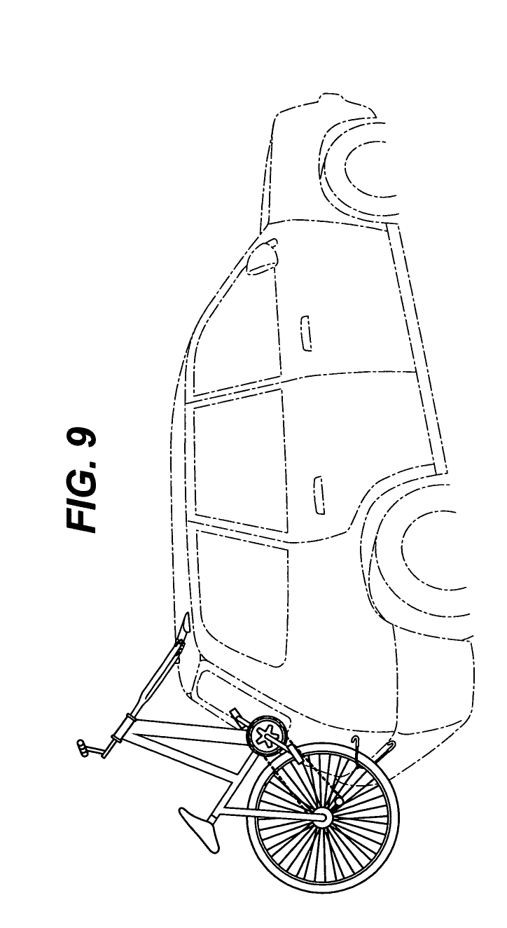

FIG. 9 illustrates how the present invention may be adapted for use with vehicles (such as SUVs) that do not have an open bed. As noted above, there is no limitation as to the particular type of vehicle that may take advantage of the invention. Of course, the examples in FIGS. 4 and 8-9 are merely representative of the general concept.

The present invention provides many advantages. Generally, the invention provides for an angled vehicle article carrier and bicycle rack system, which comprises a (preferably) single roof rail system that secures the front forks of a bicycle on the roof of a truck or vehicle, with the rear tire being secured to the bed of a truck or the lower back portion of a vehicle. The roof rail system is easily attached to the roof of a vehicle. The front forks of the bicycle are secured to a mounting system that securely attaches to the roof rails. The mounting system securely attaches to single roof rail system and the bicycle forks attach to the mounting system. As illustrated above, one end of the mounting system is endowed with a quick release apparatus that fastens or unfastens the bicycle forks. The security component apparatus typically comprises a simple attachment system, e.g., a bracket, bungee cord or a security strap, that secures the rear of the bicycle to either the bed of a truck or to the rear of a vehicle.

One of ordinary skill in the art will appreciate that the system of the present invention may be manufactured and/or provided as original equipment on a vehicle, as an aftermarket product designed to be placed on a vehicle upon or after delivery of the vehicle. Preferably, the system consists of a set of components: a support member, the fork mount, and the component for securing the rear wheel of the bicycle. Preferably, the fork mount has a quick release mechanism, as has been described.

The unique positioning of the bicycle within a truck bed according to the present invention (in the embodiment of FIG. 4) has other significant advantages. As one of ordinary skill will appreciate, the placement of the vehicle at a 45° angle relative to the truck bed ensures that the bicycle or any component parts come through the rear cab window of the truck in the unfortunate event of a collision. This provides a significant degree of additional safety when transporting the bike.

As mentioned above, the present invention may be implemented as simply an add-on to an existing truck or vehicle “spoiler”—which is a device designed to reduce drag but that also has a similar construction to the crossbar that is used in the illustrative embodiment. Support member is an aerodynamically extruded aluminum alloy crossbar, designed to minimize drag and wind noise. By securing the fork mount to an existing spoiler configuration, an aesthetically pleasing and easy-to-use bicycle mounting system is created. Indeed, in this alternative embodiment, the entire system may comprise two basic components: the fork mount, together with a device to secure the bicycle rear wheel in the truck bed. As is well known, a truck bed typically includes footman loops and holes built into the trunk bed itself so that the back wheel of the bicycle may be secured using a simple strap, cord, tether, or other convenient fastener. In this simple embodiment, the 45° mounting system is implemented using just the fork mount and the fastener, provided, for example, as an add-on or aftermarket-style “kit.”

Of course, although not illustrated in detail, one of ordinary skill will also appreciate that the unique mounting mechanism of the present invention may be used with more than one bicycle, and/or with respect to articles besides bicycles. There is no particular limitation as to where the fork mount must be positioned relative to the crossbar either, so long as the bicycle is adequately secured to the truck bed.

Each of the crossbar and fork mount components may be formed of any convenient materials, e.g., powder-coated aluminum or metal, a composite, an injection-molded plastic, a combination or the like.

Although not illustrated in detail, it is not required that the fork mount secure both portions of the bicycle fork (i.e., both forks). The mount may only secure one of the portions. Of course, the front portion of the bike (even with the wheel) may be secured to the crossbar in any convenient manner. Of course, “front” and “back” as used herein are merely for illustration purposes. Which end of the bicycle is supported above and which end is supported below is not a limitation of the invention.

Of course, variations in size, materials, shape, form, function and manner of operation, assembly and use, are deemed readily apparent and obvious to one skilled in the art, and all equivalent relationships to those illustrated in the drawings and described in this written description are intended to be encompassed by the present invention.

1. A system for use in conjunction with a vehicle and a bicycle; the vehicle having a first support surface extending in a plane, and a second support surface; the bicycle having a fork in which a wheel is normally mounted, and an opposing wheel, the system comprising:
a support member adapted to be secured to the first support surface of the vehicle; and
a mount attachable to the support member and adapted to receive and secure the fork of the bicycle for rotation about an axis extending through the mount such that, with the fork secured to the mount, the bicycle is positioned at a given angle relative to the plane of the first support surface with the opposing wheel of the bicycle located on or adjacent the second support surface.

2. The system as described in claim 1 further including a component that is adapted to secure the opposing wheel adjacent to the second support surface.

3. The system as described in claim 2 wherein the component is a strap.

4. The system as described in claim 2 wherein the component is a flexible cord.

5. The system as described in claim 2 wherein the component is a bracket.

6. The system as described in claim 1 wherein the mount includes a quick release mechanism.

7. Bicycle carrier system for use in conjunction with a vehicle and a bicycle, the vehicle having a first support surface extending in a plane, and a second support surface, the bicycle having a fork in which a wheel is normally mounted, and an opposing wheel, the system consisting essentially of:
a single support member adapted to be secured to the first support surface of the vehicle;
a mount attachable to the single support member and adapted to receive and secure the fork of the bicycle for rotation about an axis extending through the mount such that the opposing wheel of the bicycle is capable of being positioned to rest on or adjacent the second support surface; and
a component that is adapted to secure the opposing wheel on or adjacent the second support surface.

8. The bicycle carrier system as described in claim 7 wherein the mount includes a quick release mechanism.

9. The bicycle carrier system as described in claim 7 wherein the component is a strap.

10. The system as described in claim 7 wherein the component is a flexible cord.

11. The system as described in claim 7 wherein the component is a bracket.

12. In a vehicle having a first support surface extending in a plane, and a second support surface located in a plane substantially parallel to and below the plane of the first support surface, the improvement comprising: <
a single support member secured to the first support surface; and
a mount attachable to the single support member and adapted to receive and secure a fork of a bicycle for rotation about an axis extending through the mount such that an opposing wheel of the bicycle is capable of being positioned adjacent the second support surface.

13. In the vehicle as described in claim 12, the improvement further comprising a component that secures the opposing wheel of the bicycle to the second support surface.

14. In the vehicle as described in claim 12 wherein the first support surface is a roof of the vehicle and the second support surface is a bed.

15. In the vehicle as described in claim 12 wherein the first support surface is a side rail of the vehicle and the second support surface is a bed.

16. In the vehicle as described in claim 15 wherein the bicycle is positioned across the bed of the truck.

17. A vehicle having a roof extending in a plane, the roof having a front edge and a rear edge, comprising:
a single support member adapted to be secured across the roof at or adjacent the rear edge; and
a mount attachable to the single support member and adapted to receive and secure a first portion of an article for rotation about an axis extending through the mount such that, with the first portion of the article secured to the mount, the article is positioned at a given downward angle relative to the plane of the roof with a second portion of the article located on or adjacent a second support surface of the vehicle.

18. A vehicle having a side rail extending in a plane, and a storage bed extending in a plane substantially parallel to and below the plane of the side rail, comprising:
a single support member adapted to be secured along the side rail; and
a mount attachable to the single support member and adapted to receive and secure a first portion of an article for rotation about an axis extending through the mount such that, with the first portion of the article secured to the mount, the article is positioned at a given downward angle relative to the plane of the side rail with a second portion of the article located on or adjacent the storage bed.

19. The vehicle as described in claim 18 wherein the given downward angle is approximately 45 degrees.

20. The vehicle as described in claim 18 wherein the article is a bicycle.

21. In a vehicle having a first support surface extending in a plane, a second support surface located in a plane substantially parallel to and below the plane of the first support surface, and a crossbar secured to the first support surface adjacent a rear edge of the first support surface; the improvement comprising: I
a mount attachable to the single support member and adapted to receive and secure a portion of a bicycle for rotation about an axis extending through the mount such that an opposing wheel of the bicycle is capable of being positioned adjacent the second support surface; and
a component that secures the opposing wheel of the bicycle to the second support surface.

22. In the vehicle as described in claim 21 wherein the mount is a fork mount and the portion of the bicycle is a fork.
